(19) United States
(12) Patent Application Publication
(10) Pub. No.: US 2007/0018958 A1
(43) Pub. Date: Jan. 25, 2007

(54) Force reflective robotic control system and minimally invasive surgical device

(76) Inventors: Seyed Mahdi Tavakoli, London (CA); Rajnikant V. Patel, London (CA); Mehrdad Moallem, London (CA)

Correspondence Address: DARYL W SCHNURR;MILLER THOMSON LLP, ACCELERATOR BUILDING, 295 HAGEY BLVD., SUITE 300, WATERLOO, ON, N2L 6R5, CA

(21) Appl. No.: 10/595,492

(22) PCT Filed: Oct. 25, 2004
(86) PCT No.: PCT/CA04/01868

§ 371 Date: Apr. 23, 2006

(30) Foreign Application Priority Data
Oct. 24, 2003 (US) 60513,581

(51) Int. Cl. G09G 5/08

(52) U.S. Cl. 345/161

(57) ABSTRACT

A robotic system has been designed that can be used as a minimally invasive surgical device. The system has a master end and a slave end. The master end has five physical movements corresponding to physical movements at the slave end with five degrees of freedom. There is force feedback from the slave end to the master end for each physical movement. The interface can be one or more computers. The master end can be remote from the slave end and the slave end can be a surgical robot or a simulation program on a computer.

### BACKGROUND OF THE INVENTION

1. Field of the Invention

This invention relates to a robotic system and to a minimally invasive surgical device and to a method of operation thereof where said system has at least four degrees of freedom and a force feedback from a slave end to a master end for each degree of freedom.

2. Description of the Prior Art

A force reflecting haptic interface is described in WO 95/10080 having three degrees of freedom. U.S. Pat. No. 6,201,533 describes a method and apparatus for applying force in force feedback devices using friction. WO 97/19440 describes a method and apparatus for providing force feedback for computer systems.

Previous devices do not have a sufficient number of degrees of freedom and/or, do not provide force feedback in a sufficient number of degrees of freedom. When there is insufficient force feedback, a user of the device does not experience the same feeling or touch that the user would experience in carrying out a procedure directly rather than through the device. This lack of feeling or touch transmitted to a user can result in errors or omissions or other inaccuracies in the procedure that is being performed using the device.

### SUMMARY OF THE INVENTION

It is an object of the present invention to provide a robotic system and/or a minimally invasive surgical device having at least four degrees of freedom corresponding to four physical movements wherein there is force feedback for each degree of freedom. Preferably, there are five degrees of freedom and force feedback for each degree of freedom.

A robotic system comprises a master end and a slave end with an electronic interface located between the master end and the slave end. The slave end is physically controllable for several physical movements by physical movements at the master end. The master end and the slave end each have at least four degrees of freedom. The slave end has force measurement elements for each of the at least four degrees of freedom. The force measurement elements on the slave end are constructed to provide signals to the master end. The master end is constructed to receive the signals from the slave end and to emulate each force applied at the slave end at the master end. The interface passes signals between the master end and the slave end.

Preferably, the robotic system is a teleoperated system.

A minimally invasive surgical device has a master end and a slave end with an electronic interface between the master end and the slave end. The slave end is physically controllable for several physical movements by physical movements at the master end. The master end and the slave end each have at least four degrees of freedom. The slave end has force measurement elements for each physical movement. The force measurement elements on the slave end are constructed to provide signals to the master end. The master end is constructed to receive signals from the slave end and to emulate each force applied to the slave end at the master end. The interface passes signals between the master end and the slave end.

In minimally invasive surgery, part of the slave end is shaped to be inserted into a patient through a small incision.

Preferably, both the robotic system and the minimally invasive surgical device have five degrees of freedom and force feedback for all five degrees of freedom from the slave end to the master end.

A robotic system comprises a master end and a slave end with an interface located between the master end and slave end. The slave end is physically controllable for at least one physical movement by at least one physical movement at the master end. The master end and the slave end each have at least one degree of freedom, the at least one degree of freedom being a roll. The slave end has a force measurement element for the roll at the slave end. The force measurement element is constructed to provide a signal to the master end, the master end being constructed to receive the signal from the slave end and to emulate at the master end each force applied to the roll at the slave end.

A robotic system comprises a master end and a slave end with an interface located between the master end and the slave end. The slave end is physically controllable for at least one physical movement by at least one physical movement at the master end. The master end and the slave end each have at least one degree of freedom, the at least one degree of freedom being an opening and closing movement of a free end element at the slave end. The slave end has a force measurement element for the opening and closing movement at the slave end. The force measurement element is constructed to provide a signal to the master end, the master end being constructed to receive the signal from the slave end and to emulate at the master end each force applied to the free end element at the slave end.

A method of operating a robotic system having a master end and a slave end with an electronic interface therebetween uses a slave end that is physically controllable for several physical movements by physical movements at the master end. The master end and the slave end each have at least four degrees of freedom. The slave end has force measurement elements thereon for each of the at least four degrees of freedom. The force measurement elements on the slave end are constructed to provide signals to the master end. The master end is constructed to receive the signals from the slave end and to emulate each force applied at the slave end at the master end. The interface passes signals between the master end and the slave end. The method comprises physically moving the master end through the at least four degrees of freedom to cause the slave end to physically move through the at least four degrees of freedom, detecting force feedback at the master end from signals generated from physical movement at the slave end.

Preferably, the robotic system has at least five degrees of freedom and the method includes the step of detecting at the master end physical movements for all of the at least five degrees of freedom at the slave end.

Preferably, the interface of the robotic system and/or the minimally invasive surgical device is a computer and the slave end is a simulation program.

Preferably, the robotic system and/or the minimally invasive surgical device has an interface that is at least two computers that are connected to communicate with one another, the master end and the slave end being remote from one another.

### BRIEF DESCRIPTION OF THE DRAWINGS

In FIG. 1, there is shown a schematic partial perspective view of minimally invasive surgery occurring on a patient;

In FIG. 2, there is shown a block diagram of a master-slave robotic system with haptic feedback;

In FIG. 3, there is shown a perspective view of a master end of a robotic system;

In FIG. 4a, there is shown a perspective view of a base and a fulcrum;

In FIG. 4b, there is shown a side view of the base and fulcrum;

In FIG. 5, there is shown a perspective view of finger loops being constructed to receive force feedback;

In FIG. 6a, there is shown a perspective view of a mechanism constructed to receive force feedback in a roll movement;

In FIG. 6b, there is shown a perspective view of the mechanism of FIG. 6a from a different view;

FIG. 7 is a perspective view of a slave end of a minimally invasive surgical device;

In FIG. 8a, there is shown an exploded perspective view of a linear motor assembly for actuation of a tip;

In FIG. 8b, there is shown a partial sectional view of the linear motor assembly for actuation of the tip;

FIG. 8c is a photograph of three longitudinal members of an endosopic instrument in disassembled form;

FIG. 9 is an enlarged partial perspective view of strain gauges to measure bending moments on said laparoscopic instrument;

FIG. 10 is an enlarged partial perspective view of a gauge to measure torsional moment on said laparoscopic instrument;

FIG. 11 is an enlarged perspective view of gauges to measure axial forces;

FIG. 12 is a photograph of a load cell to measure interaction forces corresponding to opening and closing of the free-end element;

In FIG. 13, there is shown a partial perspective view of a 2-DOF gimbals assembly;

FIG. 14 is a schematic diagram of master, slave and interface interactions; and

FIG. 15 is a schematic view of a master end used with an interface and a simulation program.

### DETAILED DESCRIPTION OF A PREFERRED EMBODIMENT

This invention relates to a robotic master-slave system with haptic feedback (also called force reflection) that can be incorporated in minimally invasive surgery (MIS). As shown in FIG. 1, MIS is a cost-effective alternative to open surgery where essentially the same alterations are performed using instruments 1 designed to enter a body cavity 2 through several tiny incisions 3 of about 1 cm length, rather than one large incision. The master and slave subsystems are built and controlled such that:
The user controls the slave motions via the master interface (surgeon's console), and;
Tool-tissue interactions at the slave side (surgical site) are fed back to the user through the master interface.

This provides a sense of touch to the user. FIG. 2 shows a block diagram of the system. The user exerts force Fₕ on the master interface to move it, thus necessitating a force Fₛ to be applied on the slave manipulator (to make the slave's position Xₛ follow that of the master). Fₑ, the result of the interaction between the slave manipulator and its environment, has to be transmitted to the users' hand (as a force Fₘ).

### A. Master Subsystem

A master subsystem (assembly 4), which provides haptic feedback to the user, is shown in FIG. 3. It comprises:
1. a base 5 and a fulcrum 6 (sub-assembly 7);
2. a long shaft 8 passing through fulcrum 6 in the sub-assembly 7;
3. force-reflecting finger loops assembly (sub-assembly 9);
4. an assembly for force reflection in a roll direction (sub-assembly 10); and
5. a PHANToM haptic device (sub-assembly 12).
   A.1 Fulcrum

As shown in FIGS. 4a and 4b, the fulcrum 6 of sub-assembly 7 has a post 14 mounted on the base 5. The post 14 has a support 16 pivotally mounted at a top of said post about a pin 18. The support 16 is pivotally mounted on the pin 18. The support 16 has a cylindrical portion 20 that rotatably supports a bracket 21. The bracket 21 has a receptor 22 which receives the shaft 8 (not shown in FIGS. 4a and 4b) in an opening 23. The fulcrum realizes a virtual incision point through which the instrument is inserted into the body. From the mechanical point of view, the fulcrum 6 is a 4-DOF gimbals assembly allowing motions in roll, pitch, yaw and insertion directions. While these three angles and the displacement can be found based on measurements from the rest of the system, a potentiometer 24 is mounted on the gimbals for redundancy in measurements. For the comfort of the user, the angle α between the fulcrum mechanism and the base 5 is adjustable as shown in FIG. 4b.

A.2 Long Shaft

The long shaft acts as the laparoscopic instrument stem and is passed through the opening 23 of the fulcrum in sub-assembly 7, as shown in FIG. 3.

A.3 Force-Reflecting Finger Loops

In FIG. 5, the force reflecting finger loops assembly 9 (sub-assembly 9) is a 1-DOF haptic mechanism for gripping attached to one end of the shaft (not shown in FIG. 5). A pre-tensioned cable 26 pinned at both ends of a sector disk 28 and wrapped several times around a motor pulley 30 provides an almost zero-backlash cable transmission. A DC motor 32 is secured to a fixed handle 34 and turns the other handle 36 through the aforementioned cable transmission. The motor 32 has an encoder 38 to measure an angle of the finger loops relative to one another. Therefore, the sector disk 28 and the other handle 36 fixed to the sector disk 28 apply a force against the squeezing face of the user's thumb. Appropriate selection of the DC motor 32 guarantees low inertia and low friction of the finger loops assembly 9. The shaft 8 fits within opening 39.

A.4 Force Reflection in the Roll Direction

Two views of the 1-DOF assembly for force reflection in the roll direction 10 are depicted in FIG. 6a and FIG. 6b. A pre-tensioned cable 40 is pinned to a periphery of a disk 42 at 0 and 360 degrees and wrapped several times around the motor pulley 44 to provide a cable transmission. The two ends are pinned at the same location on a circumference of the disk. The cable has two ends with one end extending in each direction around the disk. The disk 42 is fixed to a distal end of the shaft 8 (not shown in FIGS. 6a and 6b) while the motor 46 is secured to a joint comprised of pivotally connected components 48 and 50 that connects an end point (not shown in FIGS. 6a and 6b) of the PHANToM to the distal end of shaft 8 (not shown in FIGS. 6a and 6b). Thus, the motor 46 turns the shaft 8 through the cable transmission described above, resulting in the application of a torque on the wrist of the user. The joint 48 and 50, shown in FIGS. 6a and 6b, includes one encoder 52 for measuring pitch motion and one encoder 54 for measuring yaw motion of the instrument. Also, a motor encoder 56 measures a roll angle of the shaft 8. The component 50 is fixed to a frame 58.

A.5 PHANToM Haptic Device

As shown in FIG. 3, a PHANToM haptic device is shown in sub-assembly 12 of FIG. 3. The PHANToM is preferably a PHANToM 1.5A from Sensable Technologies Inc. and is built into the master interface (assembly 4). This haptic device provides six degrees of freedom input control, only three of which are active (i.e., provide force reflection). The PHANToM can be oriented normally or upside down and positioned in front of the base or on its side, in order to provide optimal dexterity and comfort for the user. FIG. 3 shows only a simplified drawing of the PHANToM haptic device. PHANToM haptic devices are conventional.

### B. Slave Subsystem

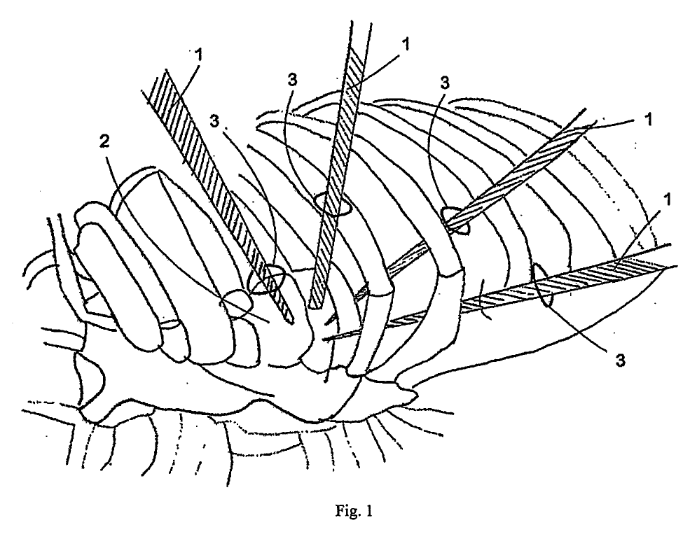

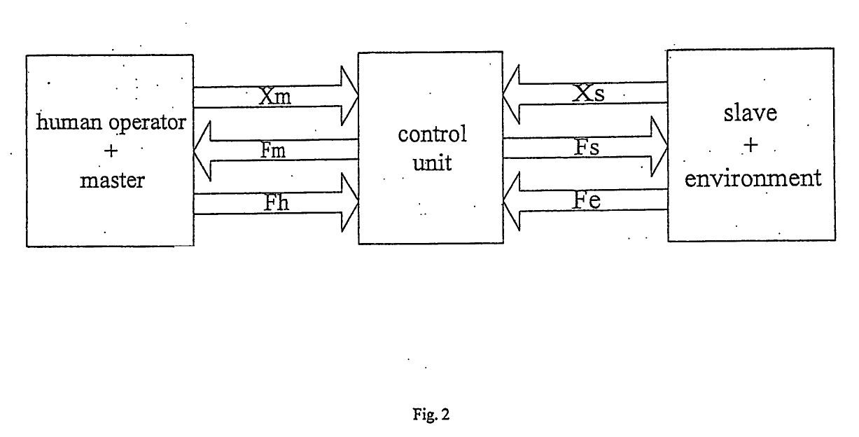

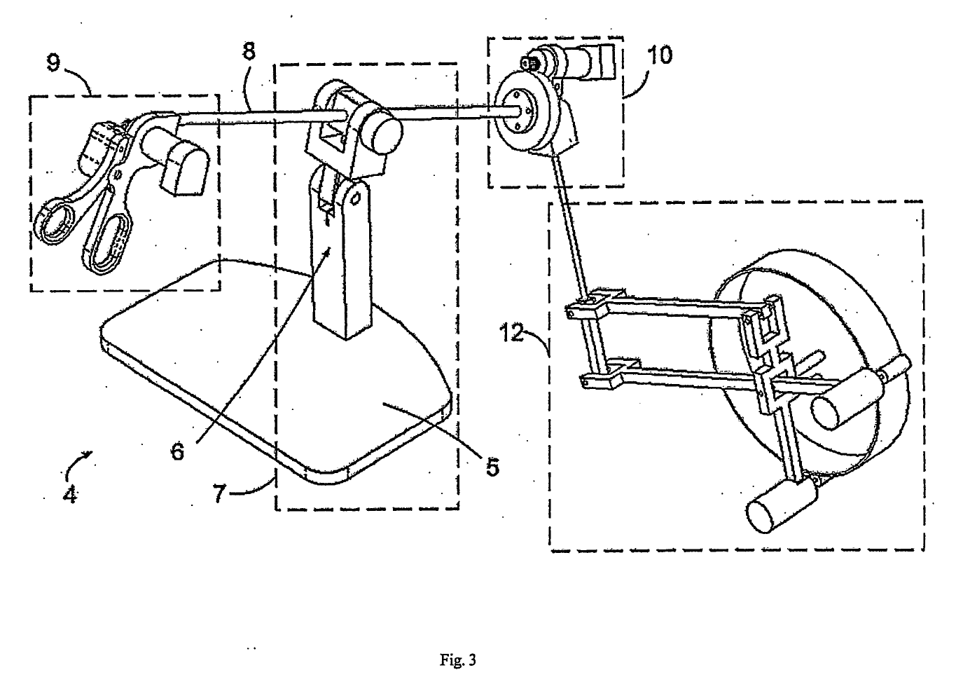

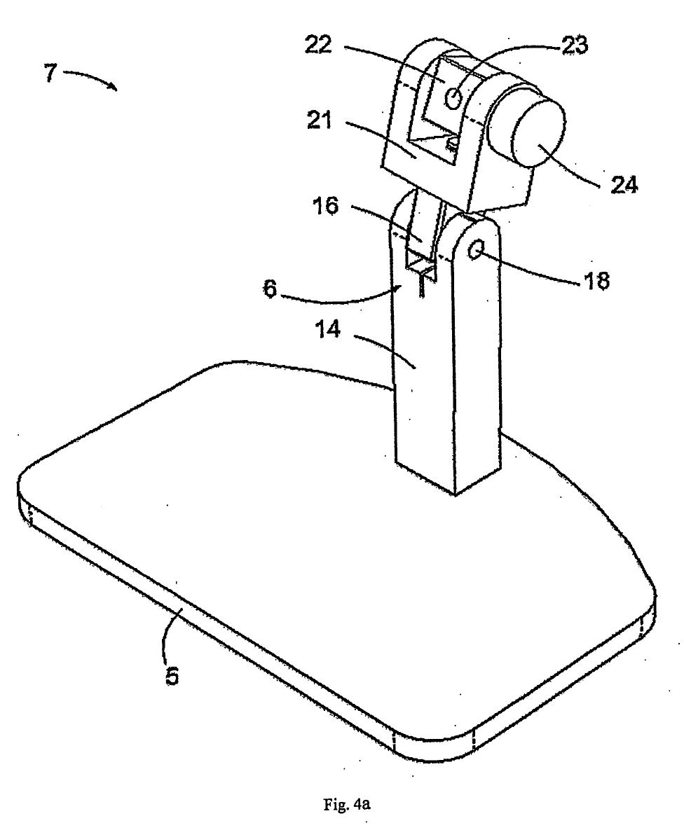

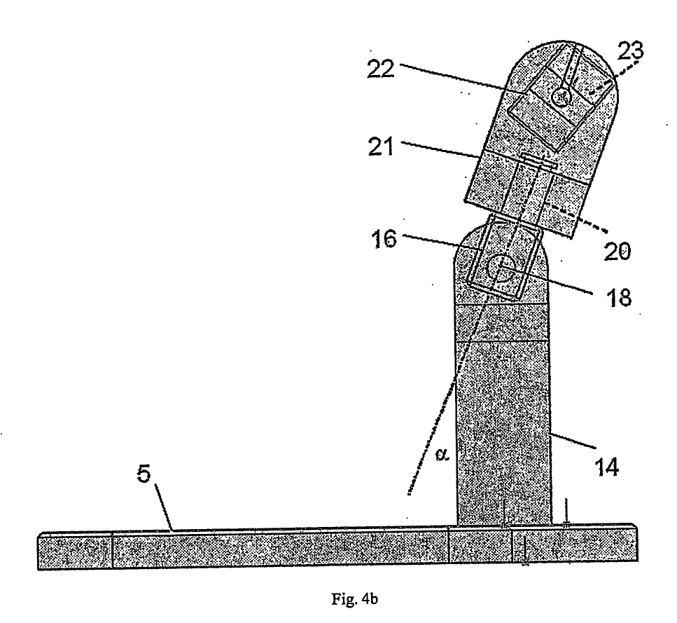

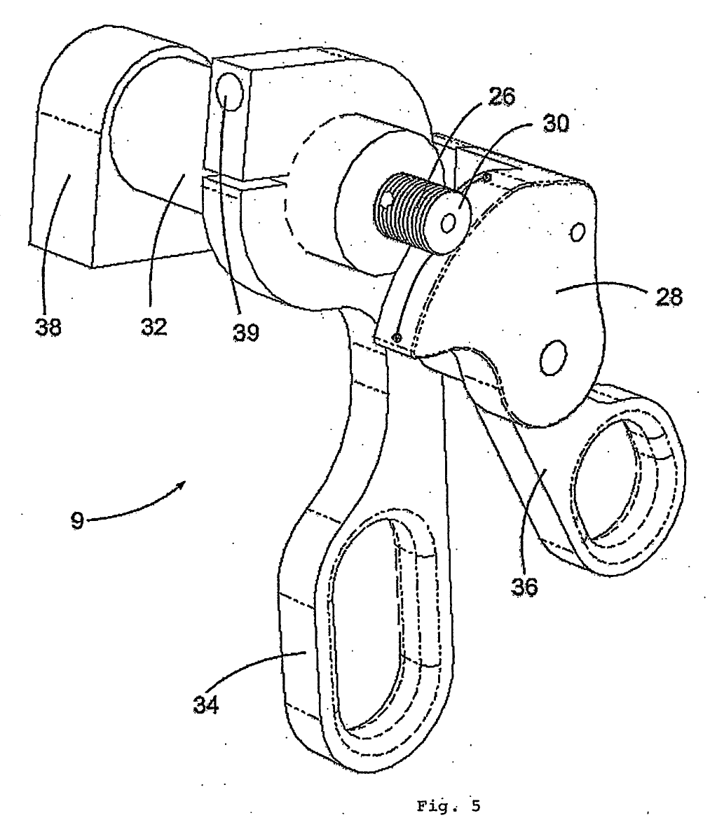

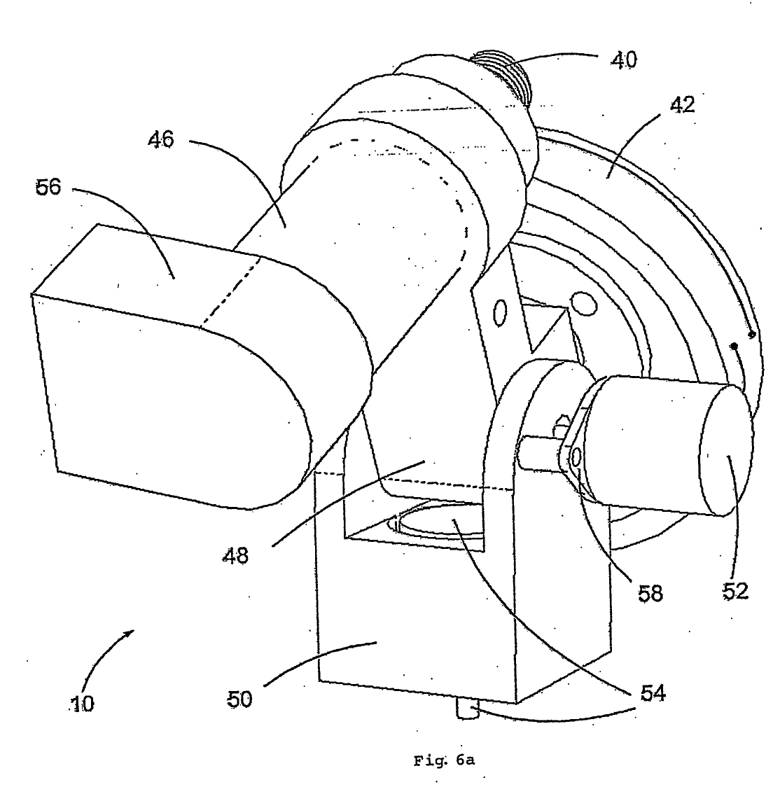

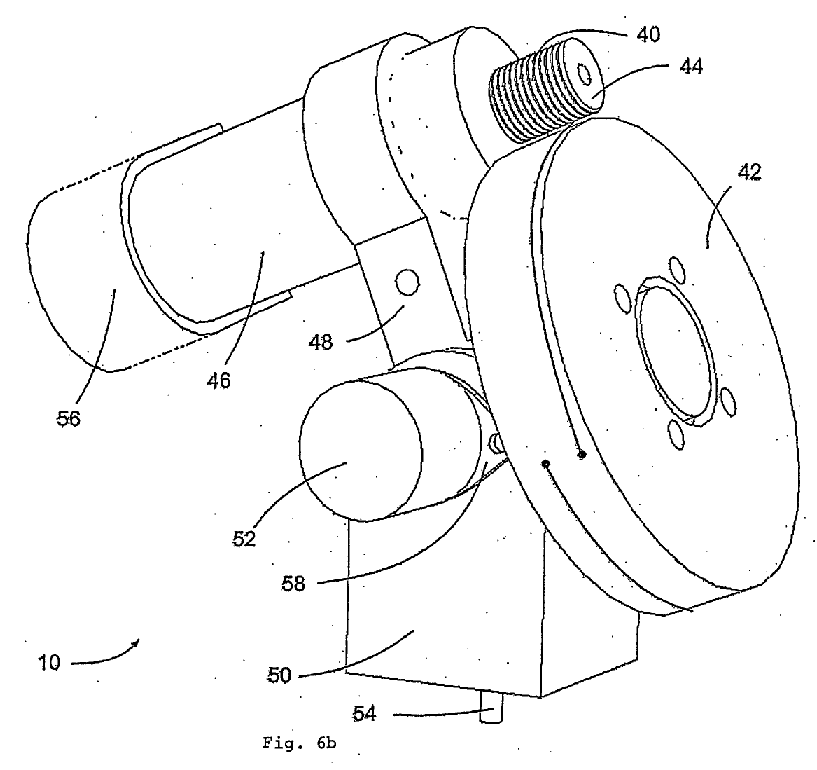

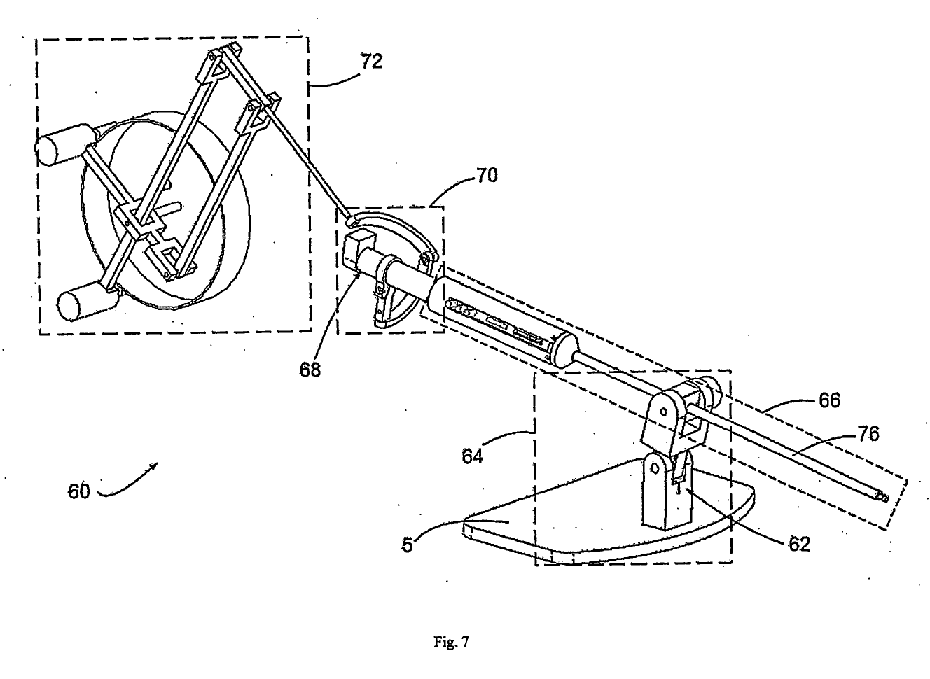

The slave subsystem (assembly 60), which acts as the surgical robot, is shown in FIG. 7. It consists of:
1. a base 5 and a fulcrum 62 (sub-assembly 64).
2. a laparoscopic instrument (sub-assembly 66).
3. a motor and encoder assembly for the roll direction (sub-assembly 68).
4. a 2-DOF gimbals assembly (sub-assembly 70).
5. a PHANToM 1.5A haptic device (sub-assembly 72).
   B.1 Fulcrum

The base 5 and the fulcrum 62 (sub-assembly 64) are similar to the master end's base 5 and fulcrum 6 (sub-assembly 7) where the angle it makes with the fulcrum mechanism can be adjusted for the user's comfort (FIGS. 3 and 4). The fulcrum 62 has a post 74 and the same reference numerals are used in FIG. 7 as those used in FIG. 4 to describe those components that are identical. The fulcrum 62, through which the instrument is inserted, will touch the incision made on the patient's body. From the mechanical point of view, the fulcrum is a 4-DOF gimbals assembly allowing motions in roll, pitch, yaw and insertion directions. The potentiometer mounted on the gimbals measures the pitch angle for measurement redundancy purposes.

B.2 The Laparoscopic Instrument Assembly

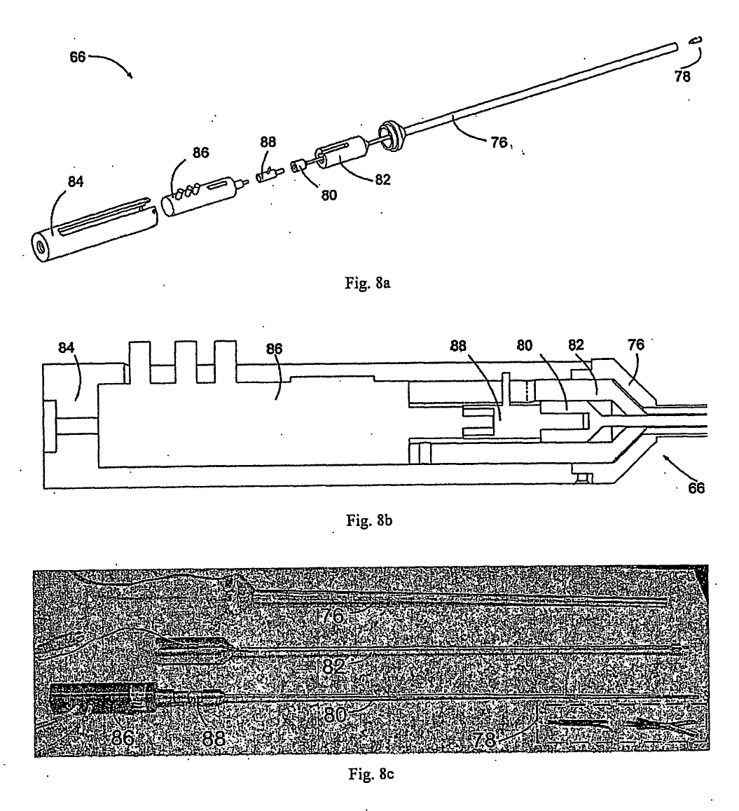

The laparoscopic instrument assembly 66 is passed through the fulcrum in sub-assembly 64 and, as shown in FIGS. 8a, 8b and 8c, consists of an instrument shaft 76, a tip actuation mechanism (not shown) and force/torque sensors (not shown).

B.2.1 The Laparoscopic Instrument

Due to the incision size constraints in MIS, the bore of this assembly is limited to less than 1 cm in diameter. Therefore, the pivotal motions of the jaws are to be actuated by a linear motion mechanism. As shown in FIGS. 8a, 8b and 8c, the sub-assembly 66 consists of several parts:
1. Detachable tips 78 which are available off-the-shelf in the form of graspers, dissectors, scissors etc.
2. An inner tube 80: This is the part actuated by the linear mechanism discussed in Section B.2.2 to control the jaws of the tip 78.
3. A middle tube 82: This tube is made to float between the shaft 76 and the inner tube 80. The floating middle tube 82 prevents the force exerted on the shaft 76 with respect to the middle tube 82 (required to actuate the tip 78) from affecting the force sensors placed on the shaft 76.
4. An outer tube 76: This is the shaft on which some force sensors are placed (see Section B.2.3.)
   B.2.2 The Tip Actuation Mechanism

FIGS. 8a, 8b and 8c show this linear actuation assembly 66 which consists of several parts:
1. A cylindrical body 84 to contain the whole mechanism. This body will be rotated by the sub-assembly 68 in response to twists of the shaft 8 (not shown in FIGS. 8a, 8b and 8c) by the user's hand and the master end (not shown in FIGS. 8a, 8b and 8c).
2. A linear motor 86.
3. A single-axis load cell 88 mounted between the linear motor 86 and the inner tube 80. The load cell 88 measures the compression/tension differential force applied between the linear motor 86 and the inner tube 80.
4. The inner tube 80. This part connects the load cell 88 to the detachable tip 78 and is displaced by the motor 86, resulting in open/close motions of the tip 78.
5. The middle tube 82. A base of the detachable tip 78 is affixed to the middle tube 82 to allow the tip to be opened and closed or otherwise operated by linear movement of the inner tube relative to the middle tube.
6. The outer tube 76. It is bolted to the cylindrical body 84.
   B.2.3 Force/Torque Measurement Devices

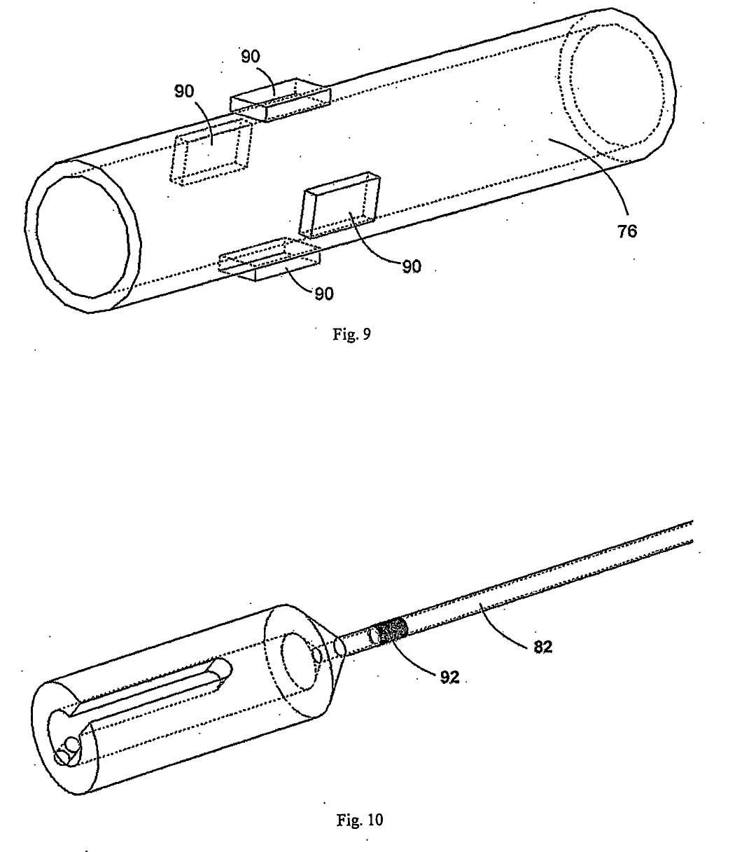

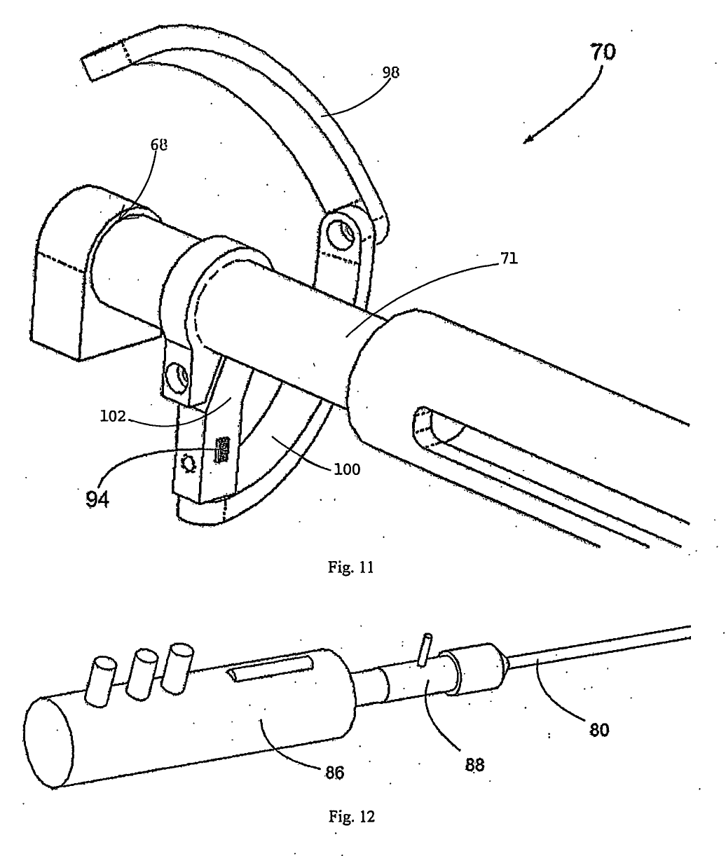

Sensors are placed to measure forces and moments in all available degrees of freedom, i.e., pitch, yaw, roll, insertion and gripping directions. In other words, the force vector (fₓ f_{y} f_{z}) and the moment τ_{z} at the end of the tip 78 as well as the interaction forces at the jaws of the tip 78 (grasping or cutting forces etc.) are measured.
1. Strain gauges 90 are located on opposite sides of the surface of the outer tube 76 such that the lateral forces at the tip 78 cause tension in one strain gauge and compression in the other (see FIG. 9). Most maneuvers involve lateral force interactions with the tissue at the instrument tip 78.
2. The torsional moments are measured by a strain gauge 92 placed on the middle tube 82 as the outer body of the tip 78 (not shown in FIG. 10) threads onto it (FIG. 10). This moment arises, for example, while suturing.
3. Compression/tension axial forces are registered by full-bridged strain gauges 94 placed on a brace 102 of sub-assembly 70 (FIG. 11). This force arises when pushing or pulling on tissue with the tip 78 (not shown in FIG. 10). The subassembly 70 has arcuate arms 90, 100 and a link 71.
4. To measure the gripping force, a load cell 88 is mounted between the motor 86 and the inner tube 80 (FIG. 12). The load cell readings correspond through a so-called force-propagation model to the force applied by the tip 78 on the tissue while grasping, dissecting, cutting it etc.

The forces on the tip are measured by measuring devices located remotely from the tip. For example, there are no strain gauges on the jaws of a grasper. Yet the gripping force on the jaws can be measured. When the system is used for minimally invasive surgery, the strain gauges are located outside of the body being operated on.

B.3 The Motor and Encoder for the Roll Direction

A geared motor and encoder (sub-assembly 68) connects the sub-assembly 66 to sub-assembly 70 by turning the sub-assembly 66 to imitate twisting the instrument by hand.

B.4 The 2-DOF Gimbals Assembly

The sub-assembly 70, which is shown in FIG. 13 and is comprised of two arcuate arms 98, 100 that are pivotally connected to one another and a brace 102 holds onto the sub-assembly 68 and is attached to the end-point of sub-assembly 72. If the sub-assembly 68 faces resistance while trying to rotate the laparoscopic instrument 66 and the tissue grasped by the tip 78, the gimbals assembly 70 will not twist into itself. This is because a main axis of the sub-assembly 68 and an axis of a revolute joint connecting the arms 98 and 100 are never parallel within the device workspace.

B.5 The PHANToM Haptic Device

Returning to FIG. 7, the PHANToM device 72 is integrated into the slave subsystem or interface 60 for simplicity of design and control. The PHANToM can be positioned in front of the base 5 and the fulcrum 62 or on its side, in order to provide optimal workspace and manipulability of the instrument 66. NOTE: FIG. 7 shows only a simplified drawing of the PHANToM device 72.

### C. Master-Slave Interaction

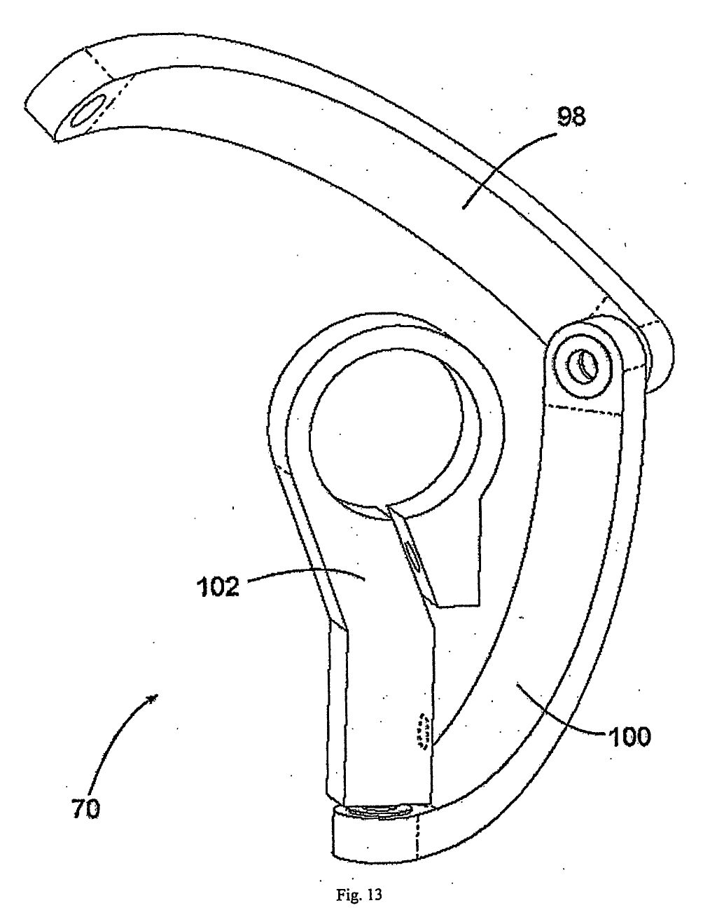

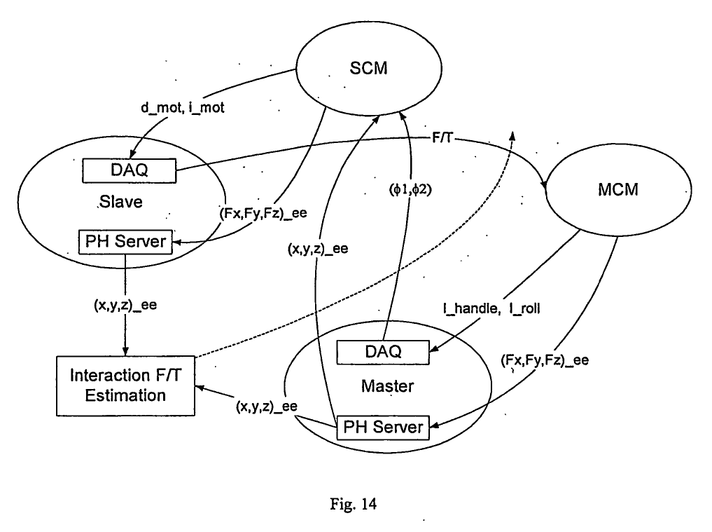

In this master-slave system, a Virtual-Reality Peripheral Network (VRPN) is used to establish an electronic interface between application programs and personal computers controlling the master subsystem 4 shown in FIG. 3 and slave subsystem 60 shown in FIG. 7. Two personal computers serve the two PHANToM devices located at the master subsystem 4 and the slave subsystem 60. Using VRPN, they are able to communicate with the Master Control Module (MCM) and the Slave Control Module (SCM). The modularity of these application programs make it is possible to run the MCM and SCM on the machines serving the PHANToMs, on a third machine or on two other machines, depending on the computational burden of the control algorithms. A block diagram of the above interactions is depicted in FIG. 14.

### ADVANTAGES AND UNIQUE FEATURES

A. Master

1. Haptic feedback is incorporated into the master subsystem (user's console) 4 in all (five) available degrees of freedom (DOFs).
2. Cog-less, low-inertia mechanisms are developed for 1-DOF force reflection in the gripping (sub-assembly 9) and roll (sub-assembly 10) directions. This results in a smooth perception of forces.
3. The master subsystem 4 components counter-balance one another to a large extent, thus reducing the weight felt on the user's hand. The residual effects are actively balanced by application of a reverse force on the instrument tip by the PHANToM device 12.
4. The master subsystem 4 has a fairly large workspace for the endpoint of the instrument 8, especially when compared to the typical size of the abdomen. The endpoint of the instrument 8 sweeps a pitch angle of 30 degrees (up and down), a yaw angle of 40 degrees (side to side), a roll angle of 360 degrees (rotation about the instrument axis) and a displacement of 22 cm along the instrument axis. Also, the angle between gripping handles 34 and 36 ranges from 0 to 30 degrees.
5. The flexible design of the master subsystem 4 allows the mechanical structure (more specifically, the PHANToM's position and orientation of the PHANToM (12) with respect to the base 5, and the tilt angle α shown in FIG. 4b to be easily modified for optimal dexterity and comfort of the user.
6. The motions of the handles 34 and 36 that are grasped by the surgeon and the instrument 8 are exactly the same as in conventional MIS, thus representing a natural feel to the MIS surgeon by preserving the same spatial mappings and geometric relationships. As such, the master subsystem 60 favors exploiting the surgeon's past cognitive and motor skills and does not require new training and, at the same time, can bring about all the advantages of robotic surgery.
7. The master subsystem 4 can be used equally well in virtual-reality surgical simulation applications. It can be used in a virtual-reality MIS simulation setting to enable a surgeon or a trainee to manipulate the surgical instruments and get haptic feedback, as well as graphics feedback, in the form of computer-generated anatomical organs.
   B. Slave
8. In the slave subsystem 60, the demanding requirements in terms of containing the thinner part of sub-assembly 66 (which includes outer tube 76, tip actuation mechanism and force/torque measurement devices in FIGS. 9 to 12) in a bore of less than 10 mm in diameter are entirely fulfilled.
9. The slave subsystem 60 is fully back drivable, i.e., one can manually move it in case of an emergency, for example, power outage.
10. The flexible design of the slave subsystem 60 allows the mechanical structure (more specifically, the position of the PHANToM 72 with respect to the base 5 and the tilt angle α shown in FIG. 4b) to be easily modified for optimal workspace and manipulability of the instrument 66.
11. The laparoscopic instrument (sub-assembly 66) and the motor/gear/encoder (sub-assembly 68) can be used with or without the free wrist (2-DOF gimbals assembly (sub-assembly 70)) depending on the kinematic properties of the surgical robot. With the wrist 70, the combination of sub-assemblies 66 and 68 can be used with any robot that provides positioning in 3-D space and with a base and a fulcrum (sub-assembly 64) placed at the trocar to form a constrained isocenter. The base and the fulcrum (sub-assembly 64) support the instrument 66 so that its movements do not damage the tissue near the trocar. Without the wrist 70, the combination of sub-assemblies 66 and 68 should be used with a robot that provides spherical movement at a Remote Center of Motion (RCM) located at the entry point.
12. The force sensing method used allows for the grasping/cutting/dissection forces to be found without having to mount sensors on the jaws of the tip 78 which may cause sterilization problems.
13. Detachable tips 78 are preferably used which can be disposed of after use, thus easing the sterilization requirements with respect to the instrument tip.
14. Generally, to measure forces and torques due to interactions between tissue and the instrument 66, a multi-axis force/torque sensor has to be mounted on the instrument shaft. The available multi-axis sensors that measure forces and torques in all six degrees of freedom are larger than 10 mm in diameter and, therefore, have to stay outside the patient. Being located outside the patient causes the sensors in previous devices to pick up unwanted abdominal wall friction and stiffness at the trocar site, causing distortions in the force feedback. In our system, the three-stage instrument assembly and the related strain gauges (FIGS. 8c, 9, 10, 11 and 12) provide a non-invasive, efficient and cost-effective solution to the problems caused by the incision size constraint in MIS.
   Master-Slave Communication and Control
15. Due to the Ethernet communication protocol used between the computers controlling the master subsystem 4 and the slave subsystem 60, the surgical robot (the slave end 60) can be teleoperated by the surgeon sitting on a remote, master console 4. This offers increased accessibility to specialists from potentially hazardous or remote locations.
16. The fact that a PHANToM haptic device 72 is integrated built into the slave subsystem 60 (as is the case with the master 4) permits one more bilateral master-slave control method to be easily implemented. In most situations, the slave 60 follows the position of the master 4 while the master 4 reflects to the user the slave-side interaction forces measured by strain-gauge sensors in FIGS. 9 to 12. This master and slave system is built not only to allow this, but also to allow the master 4 to follow the position of the slave 60 while the slave 60 reflects the force applied by the user's hand on the master 4.

### APPLICATION OF THE INVENTION

1. Minimally invasive surgery can be performed while a surgeon is sitting at a haptic-feedback console (master subsystem 4).

2. Minimally invasive surgery can be performed from a distance (telesurgery).

3. The master-slave system can be adapted for use in a therapy that requires percutaneous needle insertion, for example needle insertion for prostate brachytherapy, while haptic feedback is provided to the physician/oncologist.

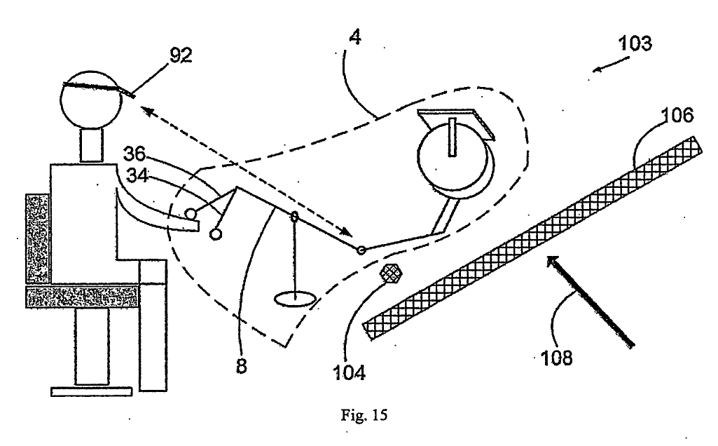

4. The master subsystem 4 can be used in virtual-reality surgical simulation applications 103 to enable a surgeon or a trainee to manipulate the handles 34 and 36 and the instrument 8 and receive haptic feedback, as well as visual feedback, in the form of computer-generated anatomical organs (FIG. 15). The idea is to enable the user to view the superimposition of the following:
a. A direct 3D view of the master instrument 8.
b. A computer-generated 3D animation of an organ 104 via a stereo display 106, for example, on the FakeSpace ImmersaDesk. Stereo-enabled computer animations of the organ 108 are fed to the stereo display 106. Therefore, the surgeon will be able to perceive the master instrument that he/she holds 8 as acting on the virtual organ 104.

5. The master interface 4 can be modified to any of the following:
c. Tool-based haptic interaction with any dynamic physical simulation.
d. A 5-DOF haptic control stick in a flight simulator or unmanned aircraft to increase the situational awareness. For instance, the operator can be made more sensitive to an exogenous disturbance (such as wind turbulence) when this signal is displayed to the operator via a force-feedback system (haptic stick). This is helpful in two regards: It gives a more natural feel of the situation to the operator, and it does not have to compete with the visual channel of the operation which is vastly over tasked in high workload situations.

6. The laparosopic instrument assembly of the slave can be used as the end-effector of any laparosopic or endoscopic robot. See part 11 of Advantages and Unique Features.

### Clinical Relevance

1. In minimally invasive surgery (MIS), the trauma to the body, the post-operative pain and the length of hospital stay are reduced significantly.
2. It is known that incorporating force feedback into teleoperated systems can reduce the magnitude of contact forces and therefore the energy consumption, the task completion time and the number of errors. The two commercially available teleoperated minimally invasive surgical systems, namely the ZEUS and da Vinci systems, only provide visual feedback to the user. In the system described here, force feedback in all five degrees of freedom available during endoscopic manipulation is provided to a surgeon.
3. Due to the ethernet communication protocol used between the master subsystem 4 and the slave subsystem 60, the surgical robot (slave, 60) can be teloperated by the surgeon sitting on a remote, master console 4. This offers increased accessibility to specialists from potentially hazardous or remote locations.

The interface for the robotic system for the minimally invasive surgical device can be one or more computers. The slave end can have a simulation program on at least one of the one or more computers so that the robotic system or the surgical device can be used as a simulator. Further, the robotic system or the surgical device can have a computer located at the master end and a computer located at the slave end. The computers can be remote from one another. The computers are arranged to communicate with one another and the master end and the slave end can be remote from one another.

Preferably, the physical movements at the master end correspond to the physical movements at the slave end and each physical movement at the slave end has a force feedback to the master end. With the opening and closing of the handle in the master end, the physical movement at the slave end is a linear movement, causing the opening and closing of the free end element in the slave end. Moreover, the insertion and removal, roll, yaw and pitch at the slave end each have corresponding physical movements at the master end.

The interface can be a first haptic device at the master end and a second haptic device at the slave end with the two haptic devices being interconnected to transmit physical movements at the master end to the slave end. The laparoscopic member at the slave end of the surgical device has strain gauges thereon. The force feedback from the slave end to the master end for each of the physical movements enables the user of the robotic system or surgical device at the master end to experience substantially the same touch and feel as a user would experience with direct physical movement. The degrees of freedom relate to different axes of rotation. The force feedback is achieved through electric motors for the physical movements at the master end that are controlled to match the force exerted by the physical movements at the slave end. The device and method can be used for minimally invasive surgery comprising endoscopic surgery and laparoscopic surgery. Where a laparoscopic instrument or member is referred to herein, that instrument can be replaced by an endoscopic instrument or member. An endoscopic instrument or member includes a laparoscopic instrument or member. Preferably, the interface between the master end and the slave end is a computer located at the master end and a computer located at the slave end. The master end and the slave end are remote from one another. The master end has at least three physical movements that correspond to at least three physical movements respectively at the slave end. The slave end can be a computer with a simulation program to teach a user the movements at the master end.

Preferably, there are at least five degrees of freedom at the master end and at the slave end and all of the degrees of freedom have force feedback from the slave end to the master end. The interface can be a first haptic device at the master end and a second haptic device at the slave end. Physical movements at the master end can be transmitted to the slave end electronically. The master end sends physical movement signals to the slave end and the slave end sends force feedback signals to the master end.

We claim:

1. A robotic system comprising a master end and a slave end with an electronic interface located between said master end and said slave end, said slave end being physically controllable for several physical movements by physical movements at said master end, said master end and said slave end each having at least four degrees of freedom, said slave end having force measurement elements for each of said at least four degrees of freedom, said force measurement elements on said slave end being constructed to provide signals to said master end, said master end being constructed to receive said signals from said slave end and to emulate each force applied at said slave end at said master end, said interface passing signals between said master end and said slave end.

2. A robotic system as claimed in claim 1 wherein said interface is one or more computers, said slave end being a simulation program on at least one of said one or more computers.

3. A robotic system as claimed in claim 1 wherein said interface is a computer located at the master end and a computer located at the slave end, said computers being remote from one another.

4. A robotic system as claimed in claim 1 wherein said interface is a computer located at said master end and a computer located at said slave end, said master end and said slave end being remote from one another.

5. A robotic system as claimed in any one of claims 1, 2 or 3 wherein at least three physical movements at said master end correspond to at least three physical movements respectively at said slave end.

6. A robotic system as claimed in claim 1 wherein there are at least five degrees of freedom of said at least four degrees of freedom, there being one degree of freedom for each physical movement at said master end and each corresponding physical movement at said slave end.

7. A robotic system as claimed in claim 1 wherein said interface has a first haptic device at said master end and a second haptic device at said slave end, said first and second haptic devices being interconnected through said interface to transmit physical movements at said master end to said slave end and vice-versa.

8. A robotic system as claimed in claim 1 wherein physical movements at said master end are transmitted to said slave end electronically and a force of each physical movement at said slave end is fed back to said master end.

9. A robotic system as claimed in claim 1 wherein said interface is one or more computers, said slave end being a simulation program on at least one of said one or more computers.

10. A robotic system as claimed in claim 1 wherein said slave end is constructed to receive signals from said master end and said master end is constructed to provide signals to said slave end.

11. a robotic system as claimed in claim 10 wherein said master end and said slave end are remote from one another, said slave end being constructed to repeat physical movements at said master end and to provide force feedback to said master end for said physical movements.

12. A robotic system as claimed in claim 10 wherein said master end is constructed to impart a roll to said slave end, said slave end having a force measurement element for said roll at said slave end, said force measurement element being constructed to provide a signal to said master end, said master end being constructed to emulate at said master end a force applied to said roll at said slave end.

13. A robotic system as claimed in claim 1 wherein said master end is constructed to impart a roll to said slave end, said slave end having a force measurement element for said roll at said slave end, said force measurement element being constructed to provide a force feedback to said master end, said force feedback at said master end being implemented by a pre-tensioned cable having two ends pinned to a disk at one location along a circumference of said disk, said ends extending around said disk in opposite directions with a motor to impart a roll motion to said disk in response to a signal from said slave end, said master end being constructed to emulate at said master end a force applied to said roll at said slave end.

14. A robotic system comprising a master end being connected to a computer, said master end having at least four degrees of freedom, said computer having a simulation program thereon so that physical movements at said master end are simulated on said computer as being physical movements on a slave end, said computer simulating force measurement elements on said slave end that are constructed to provide signals to said master end, said master end being constructed to receive said signals from said computer and to emulate each force applied at said slave end on said computer at said master end, an interface between said master end and said computer being an electronic interface, said interface passing signals between said master end and said computer.

15. A robotic system comprising a master end and a slave end with an interface between said master end and said slave end, said slave end being physically controllable for at least one physical movement by at least one physical movement at said master end, said master end and said slave end each having at least one degree of freedom, said at least one degree of freedom being an opening and closing movement of a free end element at said slave end, said slave end having a force measurement element for said movement of said free end element, said force measurement element being constructed to provide a signal to said master end, said master end being constructed to receive said signal from said slave end and to emulate at said master end each force applied to said free end element at said slave end.

16. A robotic system as claimed in claim 6 wherein said physical movements are pitch, yaw, insertion and removal, roll and movement of a free end element on said slave end.

17. A robotic system as claimed in claim 1 wherein said system is a minimally invasive surgical device, part of said slave end being shaped to be inserted into a patient through a small incision.

18. A robotic system as claimed in claim 37 wherein compression/tensional axial forces on said free end element are measured by strain gauges on a link between said endoscopic instrument and said slave end.

19. A robotic system as claimed in claim 18 wherein lateral forces on said free end element are measured by strain gauges located on opposite sides of said inner tube remote from said free end element.

20. A robotic system as claimed in claim 19 wherein torsional movements are measured by a strain gauge placed on said middle tube remote from said free end element.

21. A robotic system as claimed in claim 18 wherein said link between said endoscopic instrument and said slave end has two arcuate arms that are pivotally mounted relative to one another with a brace extending upward from a lower end of one of said arcuate arms, said brace supporting an inner end of said endoscopic instrument and containing strain gauges to measure axial forces on said free end element.

22. A robotic system as claimed in claim 17 wherein said slave end has a laparoscopic member, said laparoscopic member having a free end element located at an outer end thereof, said free end element being movable in one of said physical movements, said free end element being constructed to provide force feedback to said master end for movement of said free end element.

23. A robotic system as claimed in claim 17 wherein said part of said slave end has a diameter not exceeding substantially 10 millimetres.

24. A robotic system as claimed in claim 17 wherein said slave end has an endoscopic member, said endoscopic member having a free end element located at an outer end thereof, said free end element being movable in one of said physical movements, said free end element being constructed to provide force feedback to said master end for movement of said free end element, there being strain gauges on a support for said free end element, said support being remote from said free end element.

25. A robotic system as claimed in claim 24 wherein said endoscopic member is comprised of three concentrally mounted tubes, said tubes being movable longitudinally relative to one another, there being an outer tube, an inner tube and a middle tube, said middle tube being connected to a base of said free element and said inner tube being connected to a movable portion of said free end element so that said free element can move between an open position and a closed position by linear movement of said inner tube relative to said middle tube.

26. A robotic system as claimed in claim 24 wherein said free end element is selected from the group of a grasper, a scissors and a dissector or other cutting, grasping or dissecting means, a movement of said free end element being in a non-linear direction relative to said tubes.

27. A robotic system as claimed in claim 26 wherein there is a load cell mounted between an inner end of said inner tube and a motor to measure operational forces on said free end element.

28. A robotic system as claimed in claim 27 wherein compression/tensional axial forces on said free end element are measured by strain gauges on a link between said endoscopic instrument and said haptic device.

29. A robotic system as claimed in claim 28 wherein lateral forces on said free end element are measured by strain gauges located on opposite sides of said inner tube remote from said free end element.

30. A robotic system as claimed in claim 29 wherein torsional movements are measured by a strain gauge placed on said middle tube remote from said free end element.

31. A robotic system as claimed in claim 29 wherein said link between said endoscopic instrument and said haptic device has two arcuate arms that are pivotally mounted relative to one another with a brace extending upward from a lower end of one said arcuate arms, said brace supporting an inner end of said endoscopic instrument and containing strain gauges to measure axial forces on said free end element.

32. A robotic system comprising a slave end connected to a computer, said slave end having at least four degrees of freedom, said slave end having force measurement elements for at least one of said at least four degrees of freedom, said slave end being constructed to be physically controllable for several physical movements, part of said slave end being shaped to be inserted into a patient through a small incision, said force measurement elements on said slave end being constructed to provide signals to said computer, said computer having a simulation program so that said robotic system can be used as a simulator.

33. A robotic system as claimed in claim 32 wherein said computer is connected to provide measurements of force feedback at said slave end.

34. A robotic system as claimed in claim 33 wherein said system is a minimally invasive surgical device wherein said slave end has an endoscopic member, said endoscopic member having a free end element located at an outer end thereof, said free end element being movable in one of said physical movements, said free end element being constructed to provide force feedback to said computer for movement of said free end element, there being strain gauges on a support for said free end element, said support being remote from said free end element.

35. A robotic system as claimed in claim 34 wherein said endoscopic member is comprised of three concentrically mounted tubes, said tubes being movable longitudinally relative to one another, there being an outer tube, an inner tube and a middle tube, said middle tube being connected to a base of said free element and said inner tube being connected to a movable portion of said free element so that said free element can move between an open position and a closed position by linear movement of said inner tube relative to said middle tube.

36. A robotic system as claimed in claim 35 wherein said free end element is selected from the group of a grasper, a scissors and a dissector or other cutting, grasping or dissecting means, a movement of said free end element being in a non-linear direction relative to said tubes.

37. A robotic system as claimed in claim 36 wherein there is a load cell mounted between an inner end of said inner tube and a motor to measure operational forces on said free end element.

38. A method of operating a robotic system having a master end and a slave end with an electronic interface therebetween, said slave end being physically controllable for several physical movements by physical movements at said master end, said master end and said slave end each having at least four degrees of freedom, said slave end having force measurement elements thereon for each of said at least four degrees of freedom, said force measurement elements on said slave end being constructed to provide signals to said master end, said master end being constructed to receive said signals from said slave end and to emulate each force applied at said slave end at said master end, said interface passing signals between said master end and said slave end, said method comprising physically moving said master end through said at least four degrees of freedom to cause said slave end to physically move through said at least four degrees of freedom, detecting force feedback at said master end from signals generated from each physical movement at said slave end.

39. A method as claimed in claim 38 including the step of passing signals from said master end to said slave end to cause said slave end to repeat physical movements from said master end at said slave end.

40. A method as claimed in claim 39 including the step of using motors and encoders to receive said force feedback at said master end.
